(19) United States
(12) Patent Application Publication
(10) Pub. No.: US 2025/0232062 A1
(43) Pub. Date: Jul. 17, 2025

(54) Managing Privacy Enhancement Technology Functions

(71) Applicant: Telefonaktiebolaget LM Ericsson (PUBL), Stockholm (SE)

(72) Inventors: Jaime Jiménez, Espoo (FI); Martina Brachmann, Upplands Väsb (SE)

(21) Appl. No.: 18/698,301

(22) PCT Filed: Oct. 4, 2021
(86) PCT No.: PCT/EP2021/077248

§ 371 Date: Apr. 3, 2024

(51) Int. Cl. G06F 21/62; H04L 9/32

(52) U.S. Cl. CPC G06F 21/6254; H04L 9/3234

(57) ABSTRACT

A client device is disclosed which comprises processing circuitry configured to cause the client device to, on determining that the client device has data to send to a destination node (110), determine that at least one PET function is to be applied to the data (120). The processing circuitry is further configured to cause the client device to transmit the data, with an instruction to apply at least one PET function, to a networking device for application of the at least one PET function to the data, and for forwarding of the data to the destination node (130). Also disclosed is a networking device comprising processing circuitry configured to cause the networking device to receive client device data (210), and to detect an instruction, transmitted with the data that at least one PET function is to be applied to the data (220). The processing circuitry is further configured to cause the networking device to apply a PET function to the data in accordance with the instruction (230) and forward the data to a destination node for the data (240).

### TECHNICAL FIELD

The present disclosure relates to a client device operable to transmit data, and to a networking device operable to apply a Privacy Enhancing Technology (PET) function to the client device data. The present disclosure also relates to corresponding methods performed by a client device and a networking device, and to a corresponding computer program and a corresponding computer program product.

### BACKGROUND

The “Internet of Things” (IoT) refers to systems of devices enabled for communication network connectivity, so that these devices may be remotely managed, and data collected or required by the devices may be exchanged between individual devices and between devices and application servers. A popular vision of IoT comprises large numbers of such small autonomous devices, transmitting and receiving small amounts of data, typically relatively infrequently. IoT devices, examples of which may include sensors and actuators, are often although not necessarily, subject to severe limitations on processing power, storage capacity, energy supply, device complexity and/or network connectivity, imposed by their operating environment or situation, and may consequently be referred to as constrained devices. Constrained devices may operate according to a range of protocols, including widely used protocols such as Internet Protocol (IP) v4 or IPV6, and dedicated protocols for constrained devices, including for example the Constrained Application Protocol (CoAP).

As IoT becomes more widely adopted, there are concerns over maintaining privacy of the personal data that is collected and transmitted by connected devices. Object Security for Constrained RESTful Environments (OSCORE) is a method for application-layer protection of the Constrained Application Protocol (CoAP), using CBOR Object Signing and Encryption (COSE). OSCORE provides end-to-end protection between endpoints communicating using CoAP or CoAP-mappable HTTP. OSCORE is designed for constrained nodes and networks supporting a range of proxy operations, including translation between different transport protocols. DTLS/TLS creates a session and encrypts all data from endpoint to endpoint, but is required to create new DTLS sessions between further endpoints. In contrast, OSCORE protects payloads truly end to end, guaranteeing end to end privacy.

While encryption offers good security, it may still be possible to deduce certain information from the timing for example of encrypted communications. In addition, it may be possible to ensure privacy of some communication without resorting to encryption.

Privacy Enhancing Technologies (PETs) are collections of tools and techniques that can be employed and embedded in IoT applications to enable, enhance and preserve confidentiality and privacy. A taxonomy for such technologies is proposed by Johannes Heurix et al. in “A taxonomy for privacy enhancing technologies”, Computers & Security, Volume 53, Pages 1-17, 2015, ACM. While the presence of PET functionality on an IoT device, or networking device transmitting data from an IoT deployment, may assist with the above noted privacy concerns, the availability of PET functionality on a given device is difficult to determine, and its management is cumbersome. Even small changes such as activating or deactivating privacy enhancing functionality on devices are mostly carried out through firmware upgrades, making the devices inflexible to changes in application requirements.

Deep-packet inspection (DPI) is commonly used to provide special treatment for a subset of traffic. In DPI, the network auto-detects and differentiates traffic by examining IP addresses, ports or packet contents. New services tend to use ports 80 and 443, and use encryption, making DPI harder, more resource demanding and much less accurate at identifying user preferences. Only a few, very popular applications are included in DPI-based user preference services, as it would be costly for an operator to deal with the overhead of managing the preferences of each individual user. DPI can also be used to provide differential treatment to fulfill Service-Level Agreements (SLAs) provided by the operator, but is generally considered a “heavy” process.

### SUMMARY

It is an aim of the present disclosure to provide a client device, a networking device, corresponding methods and a corresponding computer program product which at least partially address one or more of the challenges discussed above. In particular, it is an aim of the present disclosure to provide a client device, a networking device, corresponding methods and a corresponding computer program product which cooperate to facilitate application of one or more PET functions to data transmitted by a client device.

According to a first aspect of the present disclosure, there is provided a client device comprising processing circuitry configured to cause the client device to, on determining that the client device has data to send to a destination node, determine that at least one PET function is to be applied to the data. The processing circuitry is further configured to cause the client device to transmit the data, with an instruction to apply at least one PET function, to a networking device for application of the at least one PET function to the data, and for forwarding of the data to the destination node.

According to another aspect of the present disclosure, there is provided a networking device comprising processing circuitry configured to cause the networking device to receive client device data, and to detect an instruction, transmitted with the data that at least one PET function is to be applied to the data. The processing circuitry is further configured to cause the networking device to apply a PET function to the data in accordance with the instruction and forward the data to a destination node for the data.

According to another aspect of the present disclosure, there is provided a method for operating a client device. The method, performed by the client device, comprises, on determining that the client device has data to send to a destination node, determining that at least one PET function is to be applied to the data. The method further comprises transmitting the data, with an instruction to apply at least one PET function, to a networking device for application of the at least one PET function to the data, and for forwarding of the data to the destination node.

According to another aspect of the present disclosure, there is provided a method for operating a networking device. The method, performed by the networking device, comprises receiving client device data, and detecting an instruction, transmitted with the data that at least one PET function is to be applied to the data. The method further comprises applying a PET function to the data in accordance with the instruction, and forwarding the data to a destination node for the data.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any aspect or example of the present disclosure.

Examples of the present disclosure may thus provide a mechanism to configure privacy enhancing functionality to be applied to data transmitted by a client device. The mechanism involves the use of an instruction, transmitted by the client device with the data. The instruction can be interpreted by a networking device that receives and forwards the data to a destination node, enabling the networking device to apply a PET function in accordance with the instruction.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method performed by a client device;

FIG. 2 is a flow chart illustrating process steps in a method performed by a networking device;

FIG. 3 illustrates a Network Token format;

FIGS. 4a and 4b show a flow chart illustrating process steps in another example of a method performed by a client device;

FIGS. 5a and 5b show a flow chart illustrating process steps in another example of a method performed by a networking device;

FIGS. 6a and 6b illustrate a sequence diagram of messages exchanged according to examples of the present disclosure;

FIG. 7 illustrates a protocol stack, highlighting at which layers an instruction according to the present disclosure may be inserted;

FIG. 8 is a block diagram illustrating functional modules in a client device; and

FIG. 9 is a block diagram illustrating functional modules in a networking device.

### DETAILED DESCRIPTION

Aspects of the present disclosure propose a mechanism by which a networking device receiving and forwarding client device data may be instructed to apply a Privacy Enhancing Technology (PET) function to the data. The instruction is included with data transmitted by a client device, herein also referred to as client device data, and may be interpreted by one or more networking devices receiving and forwarding the data to a destination node. In this manner, the client device may use its client device data (by including an instruction with the client device data) to indicate its preferences for the application or otherwise of PET functions to its data. This indication of preferences is provided to a network device or devices forwarding the client device data to its destination node. The network devices forwarding the client device data may consequently turn on or off PET functionality in accordance with the received instruction, allowing for differentiated use of PET functionality available at network devices, according to client device preferences for the data transmitted. The instruction is not specific to any particular application protocol, and offers a means for client devices to indicate to the network that they wish for their data to have a specific privacy related traffic differentiation.

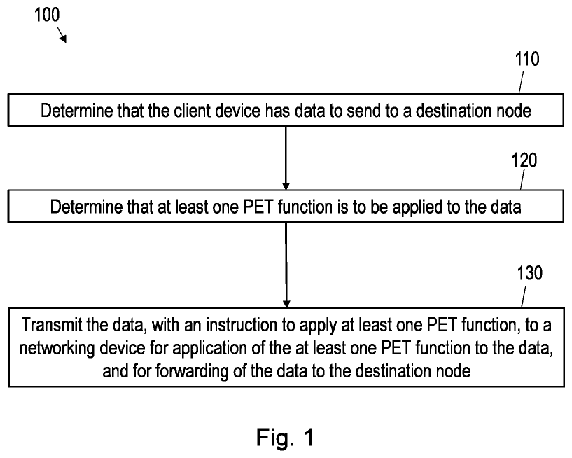

FIG. 1 is a flow chart illustrating process steps in a method 100 performed by a client device. The method 100 comprises, in a first step 110, determining that the client device has data to send to a destination node. The method 100 then comprises determining that at least one PET function is to be applied to the data in step 120. In step 130, the method comprises transmitting the data, with an instruction to apply at least one PET function, to a networking device for application of the at least one PET function to the data, and for forwarding of the data to the destination node.

For the purposes of the present disclosure, a PET function comprises a function that may be applied to any personal data, or data that may be used to derive or obtain personal data, where personal data encompasses any information relating to an identifiable person. A more complete discussion of personal data can be found in the General Data Protection Regulation (GDPR), EU Regulation 2016/679. Examples of PET functions may include a data access function, an anonymization function, a pseudo-anonymization function, a data obfuscation function, a differential privacy function, an encryption function, a secure multiparty computation function, and/or a confidential computing function. It will be appreciated that this list of example PET functions is not exhaustive, and contains several functions, including data access, encryption, secure multiparty computation, and confidential computing, whose original purpose is security, but which can also be used for privacy. Included within the scope of data obfuscation functions may be data prediction and data reduction/compression functions, although privacy is not the main purpose of such functions. Data obfuscation may also encompass techniques including changing a sampling and/or reporting period or reporting delta values as opposed to absolute values.

According to examples of the present disclosure, the client device may be a constrained device. For the purposes of the present disclosure, a constrained device comprises a device which conforms to the definition set out in section 2.1 of IETF RFC 7228 for “constrained node”. According to the definition in IETF RFC 7228, a constrained device is a device in which “some of the characteristics that are otherwise pretty much taken for granted for Internet nodes at the time of writing are not attainable, often due to cost constraints and/or physical constraints on characteristics such as size, weight, and available power and energy. The tight limits on power, memory, and processing resources lead to hard upper bounds on state, code space, and processing cycles, making optimization of energy and network bandwidth usage a dominating consideration in all design requirements. Also, some layer-2 services such as full connectivity and broadcast/multicast may be lacking”. Constrained devices are thus clearly distinguished from server systems, desktop, laptop or tablet computers and powerful mobile devices such as smartphones. A constrained device may for example comprise a Machine Type Communication device, a battery powered device or any other device having the above discussed limitations. Examples of constrained devices may include sensors measuring temperature, humidity, and gas content, for example within a room or while goods are transported and stored, motion sensors for controlling light bulbs, sensors measuring light that can be used to control shutters, heart rate monitors and other sensors for personal health (continuous monitoring of blood pressure etc.) actuators and connected electronic door locks. IoT devices may comprise examples of constrained devices.

The destination node to which the client device data is to be forwarded may be a physical node, a virtual node, a logical network function etc. In some examples, the destination node may itself comprise a constrained device.

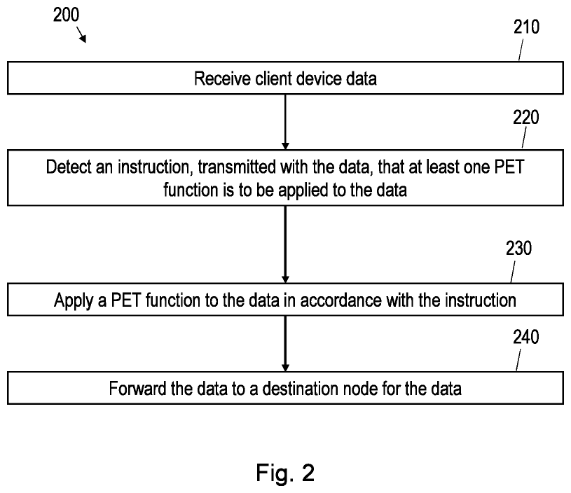

The method 100 may be complemented by a method 200 performed by a networking device as illustrated in FIG. 2. Referring to FIG. 2, the method 200 comprises, in a first step 210, receiving client device data. The method then comprises in step 220 detecting an instruction, transmitted with the data, that at least one PET function is to be applied to the data. The method 200 further comprises applying a PET function to the data in accordance with the instruction in step 230, and forwarding the data to a destination node for the data in step 240. The networking device may for example comprise a router, a server, a switching device, or any device operable to receive and forward client device data.

Examples of the present disclosure thus propose a new network service to signal privacy requirements. In some examples, as discussed below, the privacy requirements may be expressed using network token syntax.

Network Tokens (NTs) are a method for endpoints to coordinate with networks explicitly and securely about how their traffic is treated. NTs are inserted by endpoints in existing protocols, interpreted by trusted networks, and may be signed or encrypted to meet security and privacy requirements. NTs provide a means for network operators to expose data path services (such as a zero-rating service, a user driven QoS service, or a firewall whitelist), and for end users and application providers to access such services. NTs can consequently be envisaged as network cookies that allow personalizing network functionality, enabling users to tailor services by expressing their own preferences.

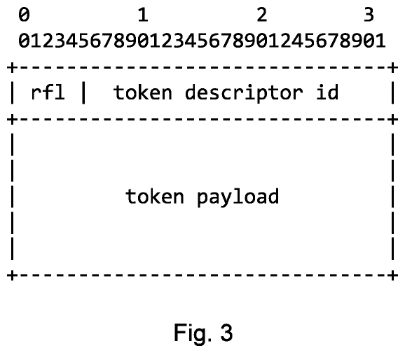

As illustrated in FIG. 3, NTs have a generic format that contains:
Reflect Type (4-bits): Indicates reflection properties for the token.
Token Descriptor ID (28-bits): An ID that helps the network decide whether and how to interpret tokens. A token descriptor might just indicate that the token payload is a JSON Web Token (JWT) for example.
Token Payload: Depending on the application, the token payload might be a self-contained JWT or CBOR Web Token (CWT) as plaintext, signed, or encrypted, a set of TLV-encoded values, or the payload may have its own custom format.

The total length of the token cannot exceed 2048 bytes.

Quality of Service (QOS) services are examples of services that can be exposed and accessed using NTs. QOS services have been historically deployed in a variety of networks, and emerging use cases like SD-WAN and 5G slicing have renewed interest in how they are implemented. QoS usually consists of tagging/identifying traffic so that a specific constraint is fulfilled, the constraint generally applying to the physical properties of the connection. Constraints are expressed in an SLA of a connectivity provider, which explains how traffic should be differentiated from different applications through respective paths.

QOS policies might be either application specific, or user driven. Application specific policies are similar to zero-rating and firewall whitelists services, and imply trust between an application provider and the network operator. User driven QoS policies imply trust between the user and the network operator, while the role of the application developer, if any, is to facilitate their interaction. QoS services are often charged based on usage, and therefore accountability and verification are important aspects of such services.

QoS taxonomies tend to consider physical aspects of the network service resources exclusively: packet loss, bit rate, throughput, transmission delay, availability, jitter, etc. To a lesser extent they may focus on the precision and security of the metrics. QoS services rarely if ever concern properties of the data, as intermediaries applying differentiated traffic handling according to QoS policies do not tend to interact with the data itself, as the data is generally encrypted and the intermediaries essentially act as pipes that transfer data.

In contrast to QoS services that may be accessed via NTs, PET functionality is applied to specific data, and is applied to the data itself, and not to the physical connection over which the data is transmitted. According to examples of the present disclosure, an instruction to apply a PET function to client device data may be expressed as a Privacy Network Token (PNT). Examples representation formats and properties of a PNT are described below, as well as implementation as a CoAP option and as an IPV6 flow label and header extension. Networking devices may, by interpreting and using PNTs, apply PETs to data marked by the PNT. In some examples, Networking devices may be Trusted Third Parties (TTPs), and PNTs may contain material enabling the networking devices to decrypt payloads in order to apply PETs to data marked by PNTs.

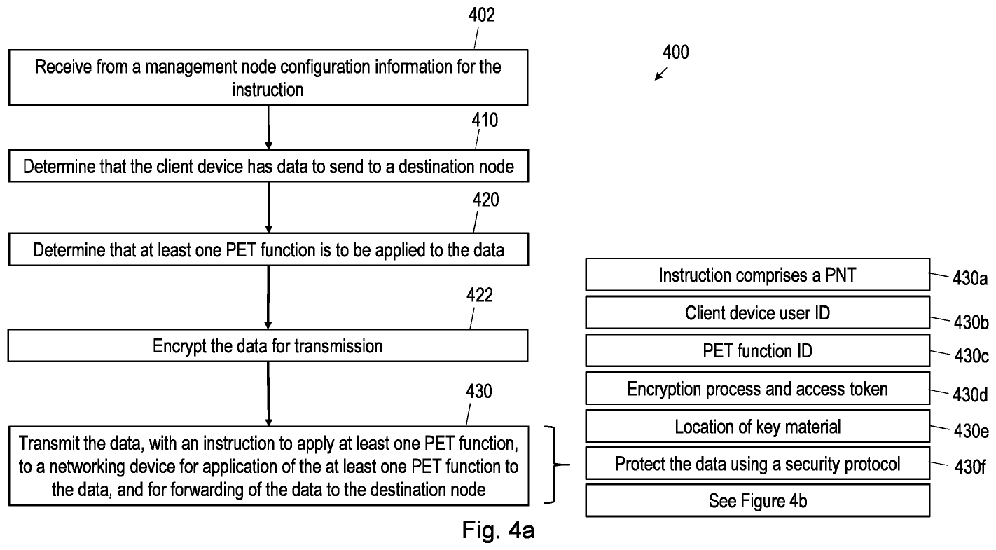

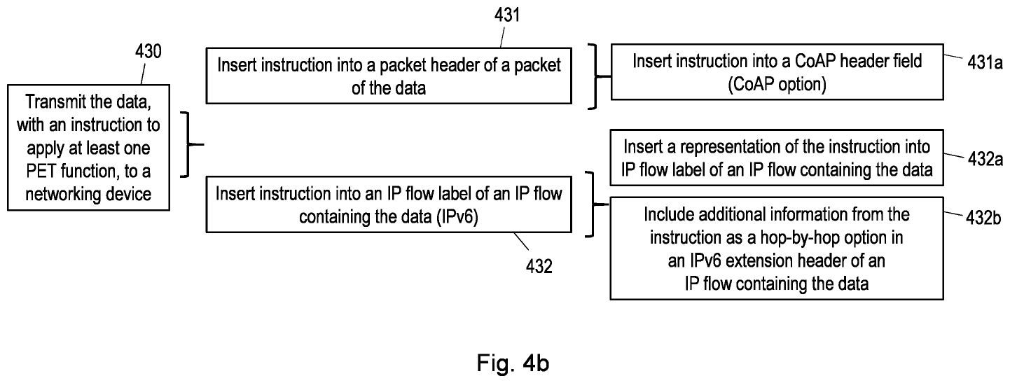

FIGS. 4a and 4b show a flow chart illustrating process steps in a further example of a method 400 performed by a client device. The steps of the method 400 illustrate example ways in which the steps of the method 100 may be implemented and supplemented in order to achieve the above discussed and additional functionality.

Referring to FIG. 4a, in a first step 402, the client device receives from a management node configuration information for an instruction to apply a PET function to client device data. The client device may consequently be provisioned with the instruction. In some examples, the instruction may have been generated by the management node that provisions it on the client device. Alternatively, the instruction may have been generated by a user via a user application. According to either option for generation of the instruction, the instruction is generated in accordance with user preferences for the degree of privacy protection to be provided to the client device data.

In step 410, the client device determines that it has data to send to a destination node. This may be a periodic transmission of data, a scheduled transmission of data, or a transmission triggered by a change in a resource value associated with the device, such as a value measured by a sensor comprised in the client device. In step 420, the client device determines that at least one PET function is to be applied to the data. In some examples, it may be that a PET function is to be applied to all client device data, in which case the step 420 may be implicit in determining at step 410 that the client device has data to transmit. In other examples, a user requirement to apply privacy protection to client device data may apply only to a specific type of client device data, in which case the client device may explicitly determine each time it has data to send whether or not a PET function should be applied to the data.

In step 422, the client device may encrypt the data for transmission. In some examples, the encryption may be TCP, OSCORE, or other options. OSCORE provides encryption and integrity protection for payloads but allows some unprotected application header fields allowing for proxy interaction and leaving open for developers to create new header fields (for example CoAP Options) that allow proxies to read them. An instruction according to the present disclosure can be implemented as such an option, as discussed in further detail below.

In step 430, the client device transmits the data, with an instruction to apply at least one PET function, to a networking device for application of the at least one PET function to the data, and for forwarding of the data to the destination node. As discussed above, and illustrated at 430a, the instruction transmitted with the data may comprise a PNT. The PNT may be expressed using the syntax of any NT, including a JSON Web Token (JWT) or CBOR Web Token (CWT), and may further comprise an expiry time for the instruction.

The instruction may further comprise an identification of a user of the client device, as illustrated at 430b. The identification may be associated with one or more user credentials, which may be stored in an appropriate repository. In some examples, the instruction may further comprise an identification of at least one PET function to be applied to the data, as illustrated at 430c. In some examples, networking devices may only have a limited PET functionality, and the instruction may for example serve essentially as a flag such that the networking device applies its unique PET function if the instruction is present. In other examples, networking devices may have multiple PET functions available, and the instruction may therefore explicitly identify the PET function that is to be applied to the data, according to the nature of the data and its sensitivity. The particular PET function may have been selected by the user of the client device. For example, some data may be most effectively protected by obfuscation, while for other data, anonymization may be the preferred option for privacy protection.

As illustrated at 430d, if the client device data has been or will be encrypted, the instruction may further comprise an identification of an encryption process used by the client device to encrypt the data. The instruction may also comprise an access token allowing access by a networking device to key material for decrypting the data. The access token may enable a networking device to obtain key material so as to be able to decrypt the client device data in order to apply the PET function. The access token may be associated with the user identification. For example, the access token may be derived from the user identification and/or a user certificate for the user identification. As illustrated at 430e, the instruction may further comprise an indication of a location from which the key material may be obtained. The location may be an identification of a key storage, for example. It will be appreciated that any of the additional information discussed above may be included in the instruction in JWT or CWT format.

As illustrated at 430f, transmitting the data may comprise protecting the data using a security protocol. In the case of an instruction transmitted as a CoAP option (as discussed in further detail below), the security protocol may comprise OSCORE, allowing for end-to-end protection while leaving some CoAP headers, including that containing the instruction, unprotected and so interpretable by intermediary network devices. In the case of an instruction transmitted as an IPV6 flow label, the security protocol may comprise TLS or some other security protocol.

FIG. 4b illustrates two different implementation options for transmitting the instruction with the client device data in step 430. According to a first option, as illustrated at 431, transmitting the instruction with the data may comprise inserting the instruction into a packet header of a packet of the data. This may comprise inserting the instruction into a Constrained Application Protocol (CoAP) header field of a packet containing the data, as illustrated at 431a. The instruction may be inserted as a CoAP option in a CoAP header field of a packet containing the data. The CoAP option may in some examples be serialized as a CBOR Web Token (CWT).

According to a second option, as illustrated at 431, transmitting the instruction with the data may comprise inserting the instruction into an Internet Protocol (IP) flow label of an IP flow containing the data. For example, the instruction may be inserted into an IPV6 flow label as specified in RFC 6437. As illustrated at 432a, the client device may insert a representation of the instruction into the IPV6 flow label field of an IP flow containing the data. The representation may be any part or function of a string containing the privacy requirement. For example, the representation may comprise a threshold number of bits from any part of the string (e.g., taken from the beginning of the string by truncating to the threshold number) or may comprise the whole of the string if the string is less than or equal to the threshold number. The representation may alternatively comprise a cryptographic function of the string such as a hash, etc. The threshold number may be bits, corresponding to the size of the IP flow label field.

As illustrated at 432b, the client device may additionally include at least one of an identification of a user of the client device, an identification of at least one PET function to be applied to the data and/or an expiry time for the privacy requirement as a hop-by-hop option in an IPV6 extension header of an IP flow containing the data. This may be envisaged for example if the IPV6 flow label field isn't long enough to contain all of this information. The information in the hop-by-hop option may be in JWT or CWT format.

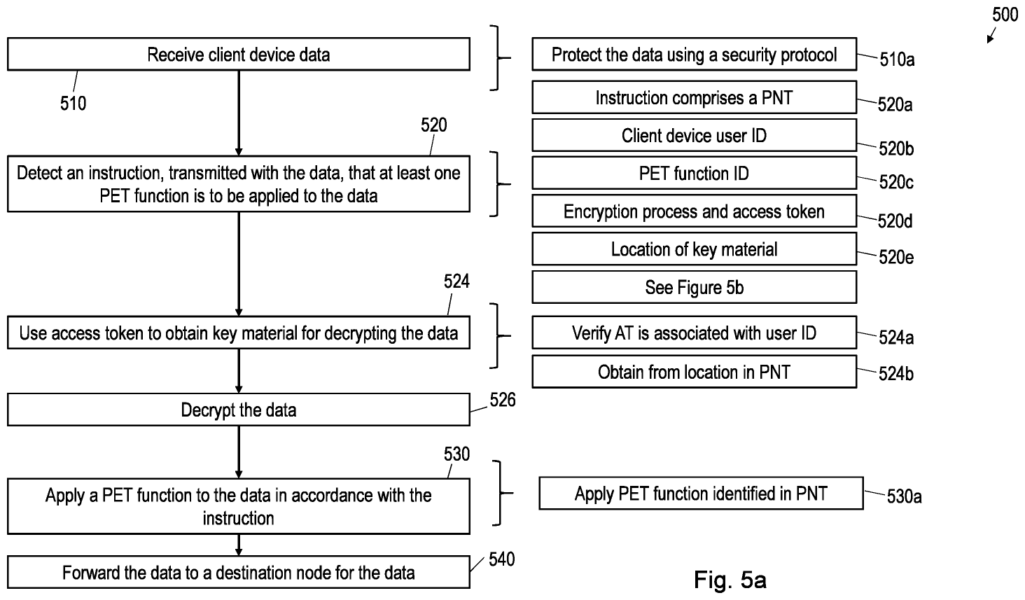

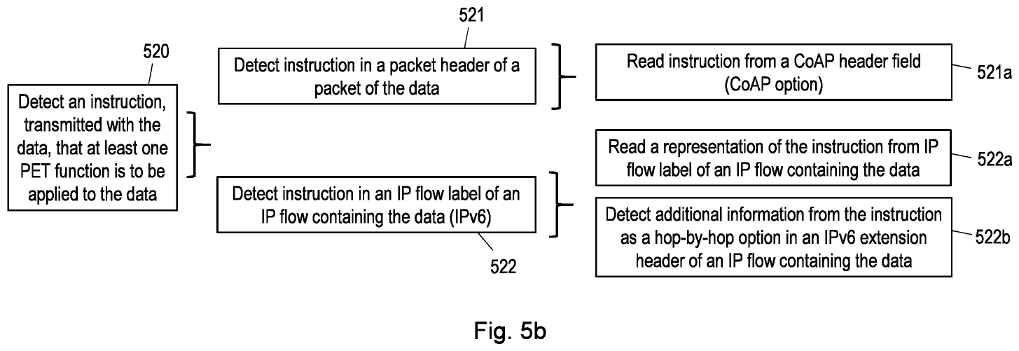

FIG. 5 shows a flow chart illustrating process steps in a further example of a method 500 performed by a networking device. The steps of the method 500 illustrate example ways in which the steps of the method 200 may be implemented and supplemented in order to achieve the above discussed and additional functionality. The networking device may for example comprise a router, a server, or a switch.

Referring to FIG. 5a, in a first step 510, the networking device receives client device data. As illustrated at 510a, the received data may be protected with a security protocol. In step 520, the networking device detects an instruction, transmitted with the data, that at least one PET function is to be applied to the data. As discussed above, and illustrated at 520a, the instruction transmitted with the data may comprise a PNT. The PNT may be expressed using the syntax of any NT, including a JSON Web Token (JWT) or CBOR Web Token (CWT), and may further comprise an expiry time for the instruction.

The instruction may further comprise an identification of a user of the client device, as illustrated at 520b. The identification may be associated with one or more user credentials, which may be stored in an appropriate repository. In some examples, the instruction may further comprise an identification of at least one PET function to be applied to the data, as illustrated at 520c. In some examples, the networking device may only have a limited PET functionality, and the instruction may for example serve essentially as a flag such that the networking device applies its unique PET function if the instruction is present. In other examples, the networking device may have multiple PET functions available, and the instruction may therefore explicitly identify the PET function that is to be applied to the data, according to the nature of the data and its sensitivity. The particular PET function may have been selected by the user of the client device.

As illustrated at 520d, if the client device data is encrypted, the instruction may further comprise an identification of an encryption process used by the client device to encrypt the data. The instruction may also comprise an access token allowing access by the networking device to key material for decrypting the data. The access token may enable the networking device to obtain key material so as to be able to decrypt the client device data in order to apply the PET function, as discussed below. The access token may be associated with the user identification. For example, the access token may be derived from the user identification and/or a user certificate for the user identification. As illustrated at 520e, the instruction may further comprise an indication of a location from which the key material may be obtained. The location may be an identification of a key storage, for example. It will be appreciated that any of the additional information discussed above may be included in the instruction in JWT or CWT format. The instruction may further comprise an expiry time for the instruction.

FIG. 5b illustrates two different implementation options for detecting the instruction in step 520. According to a first option, as illustrated at 521, detecting the instruction with the data may comprise detecting the instruction in a packet header of a packet of the data. This may comprise reading the instruction from a CoAP header field of a packet containing the data, as illustrated at 521a. The instruction may be interpreted as a CoAP option in a CoAP header field of a packet containing the data. The CoAP option may in some examples be serialized as a CBOR Web Token (CWT).

According to a second option, as illustrated at 522, detecting the instruction with the data may comprise detecting the instruction in an IP flow label of an IP flow containing the data. For example, the instruction may be detecting in an IPV6 flow label as specified in RFC 6437. As illustrated at 522a, the networking device may read a representation of the instruction in the IPV6 flow label field of an IP flow containing the data. The representation may be any part or function of a string containing the privacy requirement. For example, the representation may comprise a threshold number of bits from any part of the string (e.g., taken from the beginning of the string by truncating to the threshold number) or may comprise the whole of the string if the string is less than or equal to the threshold number. The threshold number may be 20 bits, corresponding to the size of the IP flow label field. The representation may alternatively comprise a cryptographic function of the string such as a hash, etc. The networking device may interpret the representation in order to obtain the information contained in the instruction, for example by performing a cryptographic function or by matching the representation with stored information.

As illustrated at 522b, the networking device may additionally detect at least one of an identification of a user of the client device, an identification of at least one PET function to be applied to the data and/or an expiry time for the privacy requirement as a hop-by-hop option in an IPV6 extension header of an IP flow containing the data. This may be envisaged for example if the IPV6 flow label field isn't long enough to contain all of this information. The information in the hop-by-hop option may be in JWT or CWT format.

Referring again to FIG. 5a, if the received data is encrypted, and the instruction further comprises an identification of an encryption process used by the client device to encrypt the data, and an access token, then the networking device may use the access token to obtain key material for decrypting the data at step 524. As illustrated at 524a, the networking device may verify that the access token is associated with the user identification. The access token may for example be derived from the user identification and/or a user certificate for the user identification. As illustrated at 524b, the instruction may further comprise an indication of a location from which the key material may be obtained, and the networking device may obtain the key material from the indicated location.

In step 526, the networking device may decrypt the data using the obtained key material. In step 530, the networking device applies a PET function to the data in accordance with the instruction. If the instruction includes an identification of at least one PET function to be applied to the data, then applying a PET function to the data in accordance with the instruction comprises applying the identified PET function. The networking device then forwards the data to a destination node for the data in step 540. The data may be forwarded to the destination node via one or more additional networking devices.

FIGS. 1 to 5 discussed above provide an overview of methods which may be performed according to different examples of the present disclosure. The methods involve the transmitting with client data of an instruction regarding application of a PET function. The instruction can be interpreted and acted upon by networking devices forwarding the client device data from the client device to a destination node for the data. There now follows a detailed discussion of how the instruction of the methods 100, 200, 400 and 500 may be implemented, as well as presentation of an example messaging sequence.

In the following example implementation, the instruction to apply a PET function to client device data is implemented as a PNT, as discussed above. The architecture for implementing use of a PNT includes the following elements:

An IoT Endpoint: this is the client device, which may be an IPV6 connected device or CoAP IoT device, although methods according to the present disclosure can be used with other Application Protocols. If the PNT is provisioned using the IPV6 header option, then the client device, or IoT Endpoint, should be an IPV6 connected device. The device may communicate over 3GPP networks, LoRA or WiFi networks. The IoT Endpoint may send its data using Application Layer Security protocols such as OSCORE.

A Trusted Network Element: this is the networking device, which is an intermediary node that routes traffic and can detect network tokens, and is part of a trusted network, meaning the trusted network element can be provided with the means to recover key material for decrypting client data payloads. The trusted network element can be a network element usually used for DPI or other routing entity. Network elements normally only have a stack up to the IP layer, although in some cases they might be capable of reading well-known application protocol header fields if available in the clear. The network element is also a node capable of receiving an IP flow or CoAP message, decrypting the message if the right credentials are present, and applying one or more PET functions to the data. When acting as Application Proxy the network element will break the TCP/IP connection between a client and server and hide the internal client IP addresses. The network element could be a server collocated in an Internet Service Provider (ISP) or other network, or it could be outside such networks, it could be run by the user or by a third party. The network element is able to apply PET functions (for example, anonymize, obfuscate data, pseudonymize, differential privacy) to the data collected from the device, and to forward the data to its next hop. The network element can be deployed on the user network, for example in a local gateway. The network element may fetch valid keys for decrypting the client device data by means of OAuth or PKI.

A management node, such as a Lightweight Machine to Machine (LwM2M) management server: this is an IoT management node that provisions and administers IoT endpoints. LwM2M is an example of a management protocol that may be used with IoT devices. Other management protocols may be envisaged. The management node is usually a component of the operator's network that manages IoT endpoints.

A User Application/Key Storage: this is an endpoint that interacts directly with the user for configuration purposes. The User Application/Key Storage also contains the user credentials and certificates which allow for client device data to be signed/encrypted. The User Application/Key Storage could be a laptop, mobile device, etc.

A user: the user may be an end user or may be an administrator or an enterprise using the system.

As discussed above, an instruction may be transmitted by a client device, instructing a networking node to apply one of more PET functions to the client device data. The instruction may be implemented as a Privacy Network Token (PNT), thus extending the concept of Network Tokens (NT) by adding introducing the possibility of a token that is device specific, i.e., that is assigned to and used by a device that has an owner. In contrast, standard web tokens are specific to a user or to an application or application service, and such tokens are not used in the IoT context. The PNT also places requirements that are specific to the data being sent, and not to the physical properties of the channel over which the data is sent, as is the case with web tokens.

Elements of the PNT may include:

A Token Descriptor ID of 0x01, meaning that the token payload is encoded as a JWT object.

A token payload, this may be similar to the token payload of a network token, bu may include the following additional elements:
a service ‘srv’ value for “pet”, referring to application of a PET function a “bui” (Bound User ID) field that is used to prevent other endpoints from using the token on other devices, and to identify the right key from the Key Storage. The bui is also anonymized and derived from the user certificate.
an “at” (access token) field that enables the trusted network element to access the Key Storage that contains the certificates that can be used to decrypt an encrypted payload of the client device data (encrypted for example with OSCORE). The access token is tied to a specific “bui”.
an “iss” field (the principal who signed the token). This may be the same as the “bui” or might be the identity of the device depending on the use case.

An example PNT generated by a User Application for an IoT endpoint is illustrated below:

{
″srv″:,″pet″
″bui″:″kjhsd8343″,
″exp″:345896732,
″alg″:″ES256″,
″kid″: ″iOiJIUzI1NiteIRkFbcpX4WY62SrhYf9PfJEd8″,
″at″:″wibmFtZSI6IkpvaG4gls1snwKN7TK0JTFaf19o″}

The client device data with which the PNT will be transmitted originates from a device bound to user “kjhsd8343”. The PNT is valid immediately and expires at a time indicated by the value of the exp field. The access token (at) for the user (bui) is also provided in order to decrypt and apply PET functions to the payloads. The PNT is signed using the Elliptic Curve Digital Signature Algorithm, and the public key can be looked-up in a predefined Key Store using the “kid” hash.

The example PNT is serialized as a JSON Web Token could also be compressed into a CBOR Web Token.

### Example Messaging

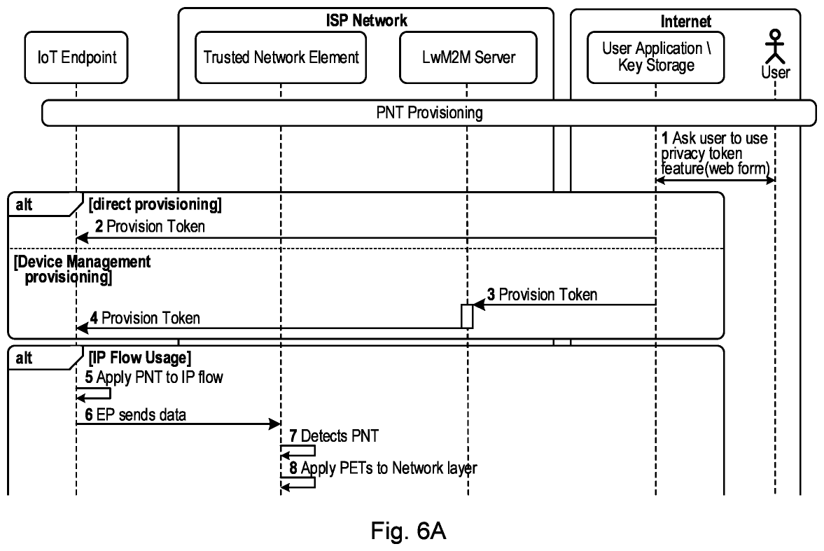

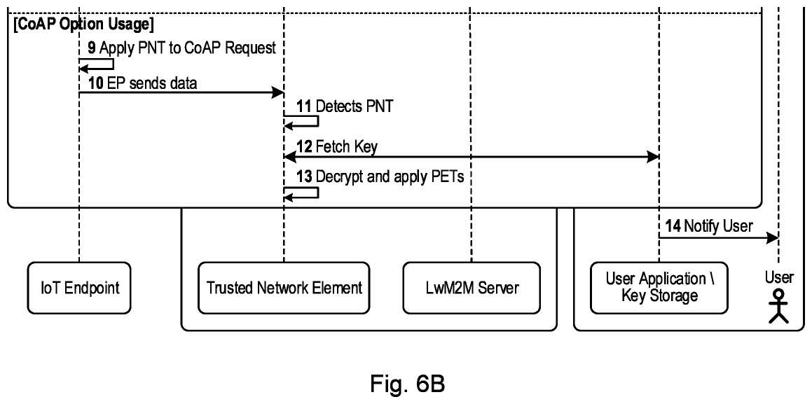

FIGS. 6a and 6b illustrate a sequence diagram of messages exchanged according to examples of the present disclosure, illustrating provisioning and use of a PNT. FIGS. 6a and 6b illustrate a provisioning phase, showing two alternative examples for provisioning a client device (IoT endpoint) with a PNT, and a use phase. In the use phase, two alternative implementation examples are illustrated, including implementation of the PNT as a CoAP option and as an IPV6 flow label.

### Provisioning Phase:

Message 1: A user is prompted by an IoT application and selects the use of QoS Privacy enhancements for its devices' network traffic. Depending on the interface, the user could have some granularity on which information can be protected with PET functionality (for example anonymized). The availability of a choice, and the data selected, may vary depending on the application domain (for example healthcare, energy, home security, etc.). The different PET functions that may be applied (pseudonymization, anonymization, etc.) may also vary, according to the nature of the data and how it will be transmitted (CoAP messages, IP flow etc.). PET functions can therefore be applied on the data payload (including headers of lower layers), for example if the data is transmitted in CoAP messages, or on the overall network traffic, if the data is transmitted in an IP flow. PET functions to the payload can prevent an attacker from retrieving personally identifiable information while PET functions applied to the overall network traffic can prevent an attacker from retrieving information about a person or household and their behavior based on traffic patterns from the endpoint.

Messages 2, or 3 and 4: Once the user has selected the client device data that is to be protected with one or more PET functions, the user application then generates a PNT and either provisions it on the device's application directly (message 2) or by means of a management protocol like LwM2M (messages 3 and 4). In LwM2M, specific objects and resources could be created to represent the PNT accurately. The PNT is bound to the user credentials or to the device credentials. The credentials can use PKI and store a Public Key in the “Key Storage”. Once the PNT is provisioned, the endpoint may communicate normally. At any point the endpoint may add the token as an IP flow field or as a CoAP Option over OSCORE security. The IP flow field is agnostic of the transfer security being used.

### Use Phase:

### IP Flow Implementation:

Messages 5 and 6: The client device (IoT endpoint) marks an IP flow containing its data with the PNT.

Messages 7 and 8: Networking nodes detect the PNT, and apply PETs the IP flow (anonymizing/randomizing IP and ports for example). PETs can be applied also to the overall network traffic coming from the device over time.

### CoAP Implementation:

Messages 9 and 10: The client device (IoT endpoint) adds the PNT as a CoAP Header option in CoAP messages containing its data. The messages are protected using OSCORE, which leaves the CoAP headers in the clear and so readable by networking devices.

Messages 11, 12 and 13: Networking nodes read the CoAP option containing the PNT, use the previously described fields (bui, kid, at) to find the public key from the Key Storage and download the key materials required to decrypt the CoAP payloads. The networking devices then apply PET functions to the individual payload contents of the request or to the overall application behavior over time.

### Both Implementations:

Message 15: The user application may notify the user when PET functions are applied to its data. This allows the user to know that the networking device is actually fetching the keys to apply PETs, although it does not give guarantees that it is being applied.

It will be appreciated that the above described messaging is merely one example of an implementation of the methods disclosed herein. Other messaging sequences may be envisaged to implement examples of the present disclosure. using examples of the present disclosure.

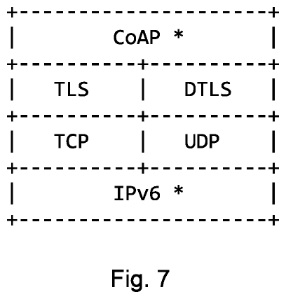

FIG. 7 illustrates a protocol stack, highlighting at which layers the PNT may be inserted. As discussed above, the PNT may be inserted as a CoAP option in the application layer, or as an IPV6 flow label.

PNT over IPv6

IPV6 flow labels are specified in RFC6437. An IP flow is defined as a sequence of packets sent from a particular source and requiring special handling by the intervening routers. The IPV6 flow label field is of length 20 bits. If the serialized PNT is too long to include in the flow label field, then a part of the PNT can be included, for example the client device may naively use the 20 first bits of the “srv” value in hexadecimal, for example “706574”. Alternatively, any 20 bits may be selected from any part of the PNT, or a cryptographic or other function may be used to transform the PNT to an appropriate length. The other function may be a hash function, or any function that outputs the required number of bits with a low chance of collisions. In some examples, for example if only the “srv” field of the PNT is represented in the IPV6 flow label, then the client device may include an additional hop-by-hop IPV6 option with other information taken from the PNT, either in JSON or CBOR Web Token format.

### PNT Over CoAP

CoAP allows for adding pieces of information to CoAP requests and responses in order for CoAP messages to be handled better, this information is included as CoAP Options. A new CoAP option “PrivacyToken” can be defined, to be supported by CoAP endpoints using PNTs, and to be included by such endpoints in their requests and/or responses. This will signal the presence of the PNT payload in the Option itself, which in CoAP is of variable length, serialized for example as a CBOR Web Token. The option number may be assigned as appropriate.

As discussed above, the methods 100 and 400 are performed by a client device and the methods 200 and 500 are performed by a networking device. The present disclosure provides a client device and networking device which are adapted to perform any or all of the steps of the above discussed methods. The client device and networking device may comprise constrained devices and/or logical or other functions.

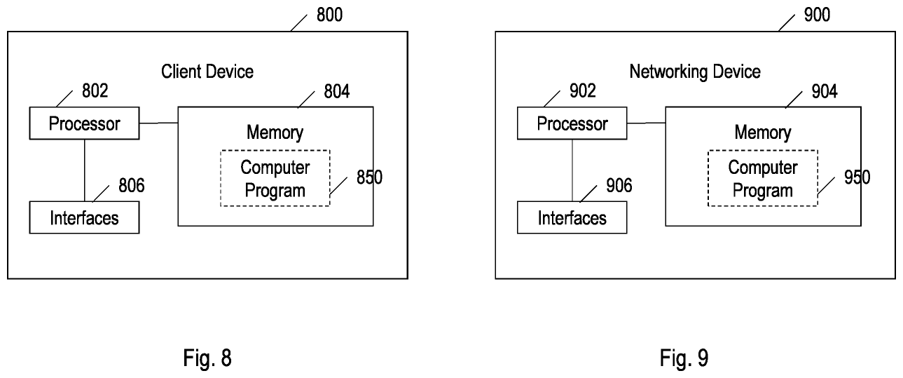

FIG. 8 is a block diagram illustrating a client device 800 which may implement the methods 100 or 400 according to examples of the present disclosure, for example on receipt of suitable instructions from a computer program 850. Referring to FIG. 8, the client device 800 comprises a processor or processing circuitry 802, and may comprise a memory 804 and interfaces 806. The processing circuitry 802 is operable to perform some or all of the steps of the methods 100 or 400 as discussed above with reference to FIGS. 1, 4a and 4b. The memory 804 may contain instructions executable by the processing circuitry 802 such that the client device 800 is operable to perform some or all of the steps of the methods 100 or 400. The instructions may also include instructions for executing one or more telecommunications and/or data communications protocols. The instructions may be stored in the form of the computer program 850. The interfaces 806 may comprise one or more interface circuits supporting wired or wireless communications according to one or more communication protocols. The interfaces 806 may support exchange of messages in accordance with examples of the methods disclosed herein.

FIG. 9 is a block diagram illustrating a networking device 900 which may implement the methods 200 or 500 according to examples of the present disclosure, for example on receipt of suitable instructions from a computer program 950. Referring to FIG. 9, the networking device 900 comprises a processor or processing circuitry 902, and may comprise a memory 904 and interfaces 906. The processing circuitry 902 is operable to perform some or all of the steps of the methods 200 or 500 as discussed above with reference to FIGS. 2, 5a and 5b. The memory 904 may contain instructions executable by the processing circuitry 902 such that the networking device 900 is operable to perform some or all of the steps of the method 200 or 500. The instructions may also include instructions for executing one or more telecommunications and/or data communications protocols. The instructions may be stored in the form of the computer program 950. The interfaces 906 may comprise one or more interface circuits supporting wired or wireless communications according to one or more communication protocols. The interfaces 906 may support exchange of messages in accordance with examples of the methods disclosed herein.

Examples of the present disclosure thus provide a mechanism for signaling user privacy requirements in a manner that is nonspecific to any one application protocol, and is compatible with use by constrained devices. A client device in accordance with examples of the present disclosure requires minimal overhead or additional resources in order to use an instruction or PNT. Existing routing, firewalling or DPI is also compatible with the use of a privacy instruction according to the present disclosure. In addition, examples of the present disclosure allow for flexibility and granularity in the application of PET functions, enhancing the functionality and diversity of solutions that currently employ only encryption.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A client device comprising processing circuitry configured to cause the client device to:
on determining that the client device has data to send to a destination node, determine that at least one Privacy Enhancing Technology, PET, function is to be applied to the data; and
transmit the data, with an instruction to apply at least one PET function, to a networking device for application of the at least one PET function to the data, and for forwarding of the data to the destination node.

2. A client device as claimed in claim 1, wherein the instruction further comprises an identification of a user of the client device.

3. A client device as claimed in claim 1, wherein the instruction further comprises an identification of at least one PET function to be applied to the data.

4. A client device as claimed in claim 1, wherein the instruction comprises a Privacy Network Token, PNT.

5. A client device as claimed in claim 1, wherein the processing circuitry is further configured to cause the client device to encrypt the data for transmission, and wherein the instruction further comprises an identification of an encryption process used by the client device to encrypt the data, and an access token allowing access by a networking device to key material for decrypting the data.

6. (canceled)

7. (canceled)

8. A client device as claimed in claim 1, further comprising:
receiving from a management node configuration information for the instruction.

9. A client device as claimed in claim 1, wherein transmitting the data, with an instruction to apply at least one PET function, comprises inserting the instruction into at least one of:
a packet header of a packet of the data; or
an Internet Protocol, IP, flow label of an IP flow containing the data.

10. A client device as claimed in claim 1, wherein transmitting the data, with an instruction to apply at least one PET function, comprises inserting the instruction into a Constrained Application Protocol, CoAP, header field of a packet containing the data.

11. (canceled)

12. A client device as claimed in claim 1, wherein transmitting the data, with an instruction to apply at least one PET function, comprises protecting the data using a security protocol.

13.-15. (canceled)

16. A networking device comprising processing circuitry configured to cause the networking device to:
receive client device data;
detect an instruction, transmitted with the data that at least one Privacy Enhancing Technology, PET, function is to be applied to the data;
apply a PET function to the data in accordance with the instruction; and
forward the data to a destination node for the data.

17. A networking device as claimed in claim 16, wherein the instruction further comprises an identification of a user of the client device.

18. A networking device as claimed in claim 16, wherein the instruction further comprises an identification of at least one PET function to be applied to the data, and wherein applying a PET function to the data in accordance with the instruction comprises applying the identified PET function.

19. A networking device as claimed in claim 16, wherein the instruction comprises a Privacy Network Token, PNT.

20. A networking device as claimed in claim 16, wherein the received data is encrypted, wherein the instruction further comprises an identification of an encryption process used by the client device to encrypt the data, and an access token; and wherein the processing circuitry is further configured to cause the networking device to:
use the access token to obtain key material for decrypting the data; and
decrypt the data;
prior to applying the PET function to the data.

21. (canceled)

22. (canceled)

23. A networking device as claimed in claim 16, wherein detecting the instruction with which the data was transmitted comprises at least one of:
detecting the instruction in a packet header of a packet of the data; or
detecting the instruction in an Internet Protocol, IP, flow label of an IP flow containing the data.

24. A networking device as claimed in claim 16, wherein detecting the instruction with which the data was transmitted comprises reading the instruction from a Constrained Application Protocol, CoAP, header field of a packet containing the data.

25.-29. (canceled)

30. A method for operating a client device, the method, performed by the client device, comprising:
on determining that the client device has data to send to a destination node, determining that at least one Privacy Enhancing Technology, PET, function is to be applied to the data; and
transmitting the data, with an instruction to apply at least one PET function, to a networking device for application of the at least one PET function to the data, and for forwarding of the data to the destination node.

31. A method as claimed in claim 30, wherein the instruction further comprises an identification of a user of the client device.

32. A method for operating a networking device, the method, performed by the networking device, comprising:
receiving client device data;
detecting an instruction, transmitted with the data that at least one Privacy Enhancing Technology, PET, function is to be applied to the data;
applying a PET function to the data in accordance with the instruction; and
forwarding the data to a destination node for the data.

33. A method as claimed in claim 32, wherein the instruction further comprises an identification of at least one PET function to be applied to the data, and wherein applying a PET function to the data in accordance with the instruction comprises applying the identified PET function.

34. (canceled)
